(19) United States
(12) Patent Application Publication
(10) Pub. No.: US 2012/0191943 A1
(43) Pub. Date: Jul. 26, 2012

(54) DYNAMIC PROTOCOL FOR COMMUNICATING COMMAND AND ADDRESS INFORMATION

(75) Inventor: Frederick A. Ware, Los Altos, CA (US)

(73) Assignee: RAMBUS INC., Sunnyvale, CA (US)

(21) Appl. No.: 13/390,683

(22) PCT Filed: Aug. 29, 2010
(86) PCT No.: PCT/US2010/047069

§ 371 Date: Feb. 15, 2012

Related U.S. Application Data
(60) Provisional application No. 61/251,160, filed on Oct. 13, 2009.

(51) Int. Cl. G06F 12/00

(52) U.S. Cl. 711/211; 711/E12.001

(57) ABSTRACT

A dynamic serialized command and address (CA) protocol with cycle-accurate matching between the PHY interface and the DFI interface is described. This CA protocol facilitates the use of a common memory-controller control logic with different CA bus configurations. With this CA protocol, CA packets for different memory operations have different formats. The size and the position of the CA packets vary relative to boundaries of DFI clock cycles, and the CA packets can extend beyond DFI clock cycle boundaries. In addition, there are at least two possible formats for a read or write memory operation. The appropriate format is selected based on the immediately preceding memory operation.

### TECHNICAL FIELD

The present disclosure relates to techniques for communicating information between circuits. More specifically, the present disclosure relates to communication between a memory controller and a memory device using a dynamic protocol.

### BACKGROUND

Communication between a memory controller and a memory device in a memory system is typically based on a predefined communication format. For example, in a given memory system, command/address (CA) information associated with a memory operation (such as activate, precharge, read, or write) may be communicated from a memory controller to a memory device on one or more CA links at a predefined signaling rate. The communication format is typically designed to be efficient, so that gaps during data communication are reduced or eliminated.

It is often advantageous to use higher signaling rates on the CA bus with fewer pins to reduce power consumption. However, because of the different number of pins and data rates used by different generations of CA bus interfaces, the translation between the internal CA information and the CA packet format used by the physical layer (PHY) can be non-trivial. For example, some memory controllers communicate information using slow, wide PHY interfaces, while other memory controllers may use narrower (i.e., with fewer wires and pins), faster interfaces. Consequently, in providing a memory controller that can interface to memory devices having different interfaces, it can be difficult to achieve cross compatible cycle-accurate matching of memory commands between the control logic in that memory controller and the physical interface of the memory controller.

### BRIEF DESCRIPTION OF THE FIGURES

This disclosure is illustrated by way of example, and not by way of limitation, in the accompanying drawings. Like reference numerals refer to similar elements. Multiple items can be referred to with two-component numerals. For example, a group of items can be denoted as “102-2,” “102-4,” “102-6,” . . . , “102-n.” These items can be collectively referred to by the first component of these numerals. For example, the items listed above can be jointly referred to with numeral “102.”

FIG. 1 illustrates two memory systems with different PHY interface configurations.

FIG. 2 illustrates CA packets for different memory operations at the DDR PHY interface (DFI) in one of the memory controllers in FIG. 1.

FIG. 3 illustrates how CA packets corresponding to the transactions illustrated in FIG. 2 are transmitted over the PHY interface in memory system 112.

FIG. 4 illustrates a PHY interface configuration which involves using three CA links to provide cycle-accurate communication between the DFI interface and PHY interface.

FIG. 5 illustrates the transmission of CA packets using various CA packet formats.

FIGS. 6-7 illustrate a mapping between the conventional fixed-length CA packet format and the dynamic CA packet format.

FIG. 8 illustrates how three column accesses to the same bank and row address can be pipelined with DFI-clock cycle accuracy using the dynamic CA format.

FIG. 9A illustrates a memory controller in a memory system.

FIG. 9B illustrates a memory device in a memory system.

FIG. 10 illustrates a variation of the dynamic CA protocol.

FIG. 11 illustrates a memory system.

FIG. 12A illustrates different OPCODE and address bits corresponding to different CA packet formats associated with different memory operations.

FIG. 12B presents an exemplary logic computation table for implementing the dynamic CA protocol in a memory controller.

FIG. 12C presents an exemplary logic computation table for implementing the dynamic CA protocol in a memory device.

FIG. 13A illustrates the CA packet format for a narrow, fast external physical interface.

FIG. 13B illustrates the CA packet format for a wide, slow external physical interface.

FIG. 14A illustrates a process for providing CA signals on the physical CA links.

FIG. 14B illustrates a process for receiving CA signals from the physical CA links.

### DETAILED DESCRIPTION

Embodiments of the present disclosure provide a dynamic command/address (CA) protocol and the corresponding PHY interface with cycle-accurate matching between the commands issued by the control logic of a memory controller and the commands transmitted over a PHY interface of the memory controller. This protocol facilitates the use of a common memory-controller control logic with different generations or standards for CA buses between memory controller and integrated circuit memory devices. In an embodiment, a CA protocol includes CA packets for different memory operations, the CA packets having different sizes and formats. The size and temporal position of the CA packets can vary relative to boundaries defined by DDR-PHY Interface (DFI) clock cycles. (DFI is an interface protocol internal to the memory controller that defines the internal protocol between memory controller logic and PHY.) Moreover, in some of the formats, a CA packet can extend across a DFI clock cycle boundary into an adjacent DFI clock cycle. In addition, there are at least two formats for a read or write memory operation. The appropriate format can be determined based on the immediately preceding memory operation, or determined based on the operation code in the current CA packet. This CA protocol and the corresponding PHY interface facilitate cycle-accurate communication between the memory-controller's control logic and different CA buses. As a result, a memory system that uses a different CA bus configuration can use the same control logic in both the memory controller and memory device.

In the following description, a DFI clock cycle refers to a time period equivalent to a clock cycle in the DFI interface (e.g., 2.5 ns for a 0.4 Gbps DFI interface). A CA packet refers to a group of bits corresponding to one memory operation command and the associated address, transmitted over the CA bus. A CA packet can include a number of operation code (OPCODE) bits, which define the command, and address bits. The operation code can be multiplexed along with the address bits.

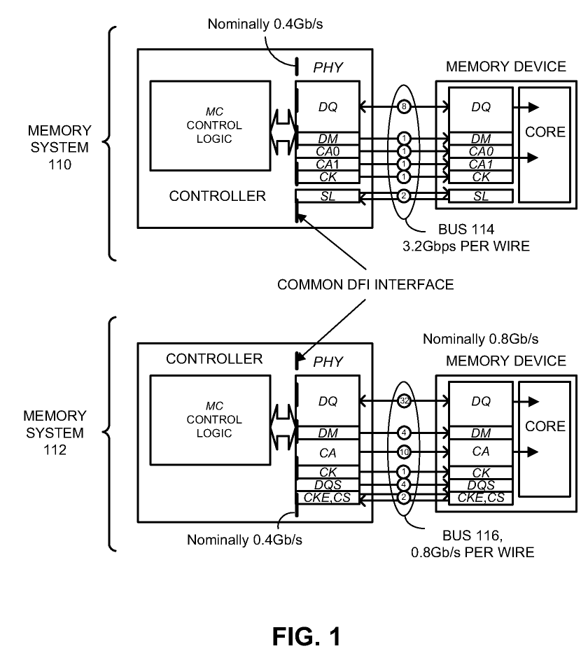

FIG. 1 illustrates two memory systems 110 and 112. Memory system 110 has a narrow, high speed physical (PHY) interface for communicating information between the memory controller (MC) and the memory device (such as dynamic random access memory or DRAM) over bus 114. The PHY interface in this example includes: 8 data (DQ) links, a data-mask (DM) link, two CA links, a clock (CK) link, and a side link (SL). Information may be communicated on these links at a nominal data rate of 3.2 gigabits per second (Gbps) using double-data-rate (DDR) signaling (wherein the physical clock period on each wire is 0.625 ns).

For comparison, memory system 112 includes a wide, low speed PHY interface for communicating information between the memory controller and a memory device such as, for example, mobile synchronous DRAM (SDRAM), double data rate SDRAM (DDR), or low-power double-data-rate (LP-DDR) over bus 116. This PHY interface includes: 32 data (DQ) links, four data-mask (DM) links, ten CA links, a clock (CK) link, four data-strobe (DQS) links, a clock-enable (CKE) link, and a chip-select (CS) link. Information may be communicated on these links at a data rate of 0.8 Gbps, wherein the physical clock period on these wires is 2.5 ns.

In order for the memory controller in memory system 110 to use the same control logic as in memory system 112 in conjunction with the fast, narrow bus 114, a CA protocol with cycle-accurate matching between the commands issued by the control logic and the commands transmitted on the physical bus 114 is provided in the PHY interface. This MC control logic may communicate with the PHY interface at a nominal data rate of 0.4 Gbps over the DFI interface. However, because the product of the number of CA bus links and the PHY data rate in memory system 112 is not the same as in memory system 110, it can be difficult to use the same MC control logic in memory systems 110 as in system 112.

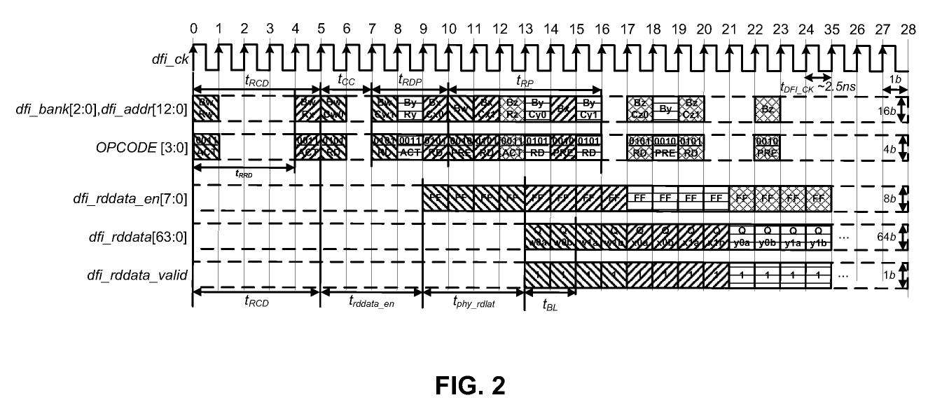

FIG. 2 illustrates CA packets for different memory operations at the DFI interface of the memory controllers in FIG. 1. In FIG. 2, the boxes illustrate CA packets; Bw, Bx, By, Bz denote different bank addresses; Rw, Rx, Ry, Rz denote different row addresses; and Cw, Cx, Cy, Cz signify different column addresses. Furthermore, boxes with the same type of hash marks (such as forward-diagonal hash marks, reverse-diagonal hash marks, vertical hash marks, or cross-diagonal hash marks) indicate memory operations at a common bank address. For example, the boxes with forward-diagonal hash marks indicate: an activation (ACT) command of a row address Rw in bank Bw at DFI clock cycle 0, read (RD) commands at two column addresses Cw0 and Cw1 in bank Bw at DFI clock cycles 5 and 7, and a precharge (PRE) operation in bank Bw at DFI clock cycle 10. Then, at DFI clock cycle 17, bank Bw is ready for another row-column access. The sequence of memory operations in FIG. 2 results in a pipelined stream of read data (dfi_rddata[63:0]) being transmitted without gaps.

In FIG. 2, the clock signal (dfi_ck) corresponds to the clock used in the DFI interface, which in this case is at 0.4 Gbps with a cycle period of 2.5 ns. The first row below the DFI clock waveform (dfi_bank[2:0], dfi_addr[12:0]) indicates the bank and row addresses communicated from the MC control logic to the PHY interface. These addresses are communicated over a 16-bit-wide bus, with one bit carried in each DFI clock cycle. The second row below the DFI clock waveform (OPCODE[3:0]) indicates the memory command corresponding to the address. The command is carried in a 4-bit OPCODE over a 4-bit-wide bus. Hence, at the DFI interface in both memory systems 110 and 112, a CA packet is carried in 20 bits (16 bits of addresses and 4 bits of OPCODE) over one DFI clock cycle.

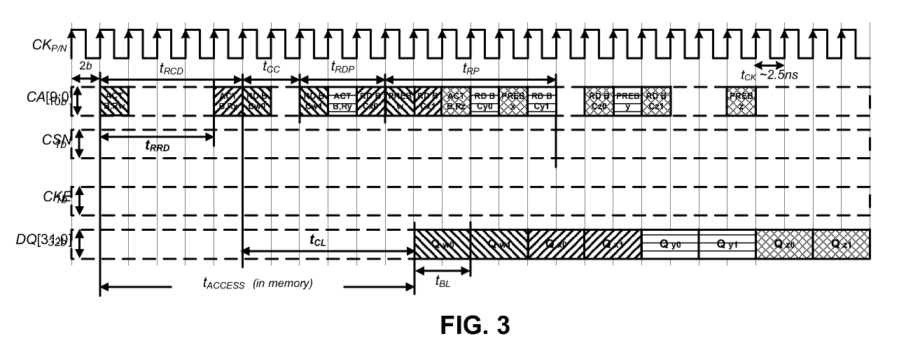

FIG. 3 illustrates how the CA packets corresponding to the transactions illustrated in FIG. 2 are transmitted over the PHY interface in memory system 112 (FIG. 1). Note that all of the memory operations illustrated in FIG. 3 are shifted by one DFI clock cycle relative to FIG. 2 to account for the processing delay between the DFI interface and the PHY interface. In memory system 112, the physical CA bus between the MC and memory device is 10-bit wide. Since the data rate on the CA bus is twice the data rate over the DFI interface, a CA packet (which contains 20 bits) can be accommodated in one DFI clock cycle over the 10-bit-wide CA bus. This configuration illustrates that when the number of CA links on the DFI interface (i.e., the number of CA links between the MC control logic and the PHY interface, which is 20 in memory system 112) is a multiple of the number of physical CA pins (i.e., the external pins coupling the MC with the memory device, which is 10 in memory system 112), the mapping of CA packets from the DFI interface to the PHY interface can be performed on a per-cycle basis with respect to the DFI clock. In other words, the CA packets on the PHY interface are cycle-accurate with respect to the CA packets on the DFI interface, and hence the MC control logic does not need to be re-designed. However, this is not the case when the number of CA links on the DFI interface is not a multiple of the physical CA pins on the PHY interface, which is the case in memory system 110.

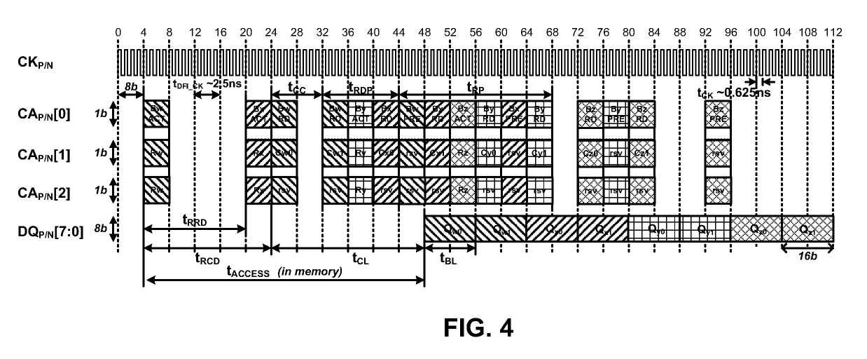

One way to solve the cycle-inaccuracy problem is to use more CA links, as illustrated in FIG. 4, so that a sufficient number of bits can be transmitted during a DFI clock cycle. In the example illustrated in FIG. 4, three CA pins, CA[0], CA[1], and CA[2], are used. Each CA link has a 3.2 Gbps data rate and can carry 8 bits during one DFI clock cycle. As a result, a CA command and the corresponding address(es), which at most are 20-bit long, can be contained within one DFI clock cycle. For example, as illustrated in FIG. 4, an ACT command and the corresponding bank and row addresses, Bw and Rw, can be transmitted during one DFI clock cycle (i.e., PHY clock cycles 4-8). This configuration, however, requires three CA pins.

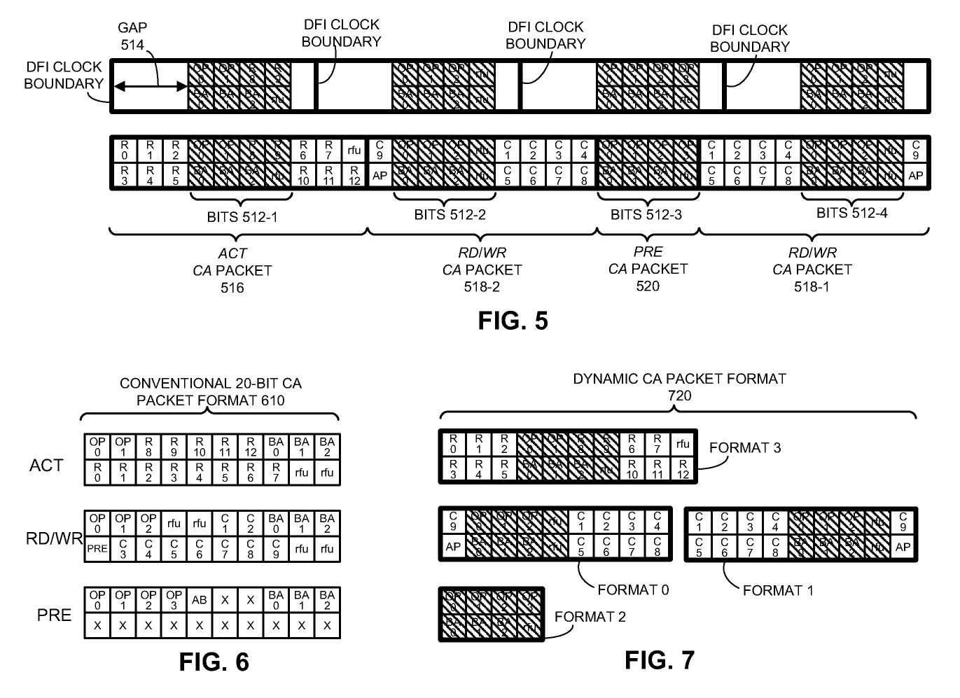

In an embodiment that solves the cycle-accuracy problem without using additional CA pins, a dynamic serialized CA protocol is introduced. This protocol facilitates different formats and sizes for different CA packets, and can effectively transmit all types of CA packets with DFI-clock cycle accuracy over two CA links. FIG. 5 illustrates how the CA packets can be transmitted in accordance with this protocol. In the top sequence in FIG. 5, the bold lines outline the DFI clock cycle boundaries. The two CA links, which operate at 3.2 Gbps, can carry 16 bits of information within one 2.5-ns DFI clock cycle. The bottom sequence shows the different CA packet formats, where each CA packet is outlined by bold lines.

Each CA packet has a certain number of bits, such as bits 512-1, 512-2, 512-3, and 512-4, which are placed in fixed positions relative to the boundary of the DFI clock cycle. These bits are marked with forward-diagonal hash patterns. To illustrate the relationship of these bits to the DFI clock boundary, these bits are also illustrated in the top sequence in FIG. 5. For example, there is a fixed gap 514 between bits 512-1 and the DFI clock boundary. These fix-positioned bits can contain OPCODE bits and some address bits, and can be used as a reference by the receiver to delineate incoming CA packets.

In an embodiment, there are at least four types of commands included n or encoded using CA packets for accessing a synchronous DRAM: activation (ACT), precharge (PRE), read (RD), and write (WR). Each type of packet has a different size and format. In addition, the RD and WR packets each have two formats.

As illustrated in FIG. 5, an ACT packet 516 includes 20 bits and extends beyond the tail boundary of a DFI clock cycle. The fix-positioned bits 512-1 within ACT packet 516 include two OPCODE bits (OP0 and OP1) that specify activating a row of memory cells (as addressed by row address bits), two row address bits (R8 and R9), three bank address bits (BA0-BA2) that identify a bank within the DRAM, and one bit reserved for future use (rfu). The rest of ACT packet contains 10 row address bits (R0-R7, R10, and R11) and one rfu bit. There are six bits before fix-positioned bits 512-1, and six bits after.

For a RD or WR packet, which has 16 bits in total, there are two formats. RD/WR packet 518-2 has two bits before fix-positioned bits 512-2, and eight bits after. These 10 bits jointly carry the column address associated with the RD or WR operation. This format is used when the preceding CA packet is an ACT packet. In a different format, as is the case with RD/WR packet 518-1, there are eight bits before fix-positioned bits 512-4, and two bits after. This format is used when the preceding CA packet is a PRE packet.

A PRE packet 520 only has fix-positioned bits 512-3, which contain four OPCODE bits that specify precharging an activated row of memory cells and three bank address bits that identify a bank within the DRAM. This PRE packet format is used to insert a PRE packet after a RD or WR packet with packet format 518-2.

Note that ACT CA packet 516 is the largest and has 20 bits. RD/WR CA packets 518-1 and 518-2 each include 18 bits. PRE CA packet 520 includes 8 bits. In addition to different sizes, framing positions of the CA packets are dynamically selected or adjusted. Therefore, with different formats, the beginning of the CA packets may occur at different positions relative to the DFI clock boundaries.

In order for the CA protocol to be cycle accurate, it needs to convert the conventional 20-bit CA packet format 610, as illustrated in FIG. 6, to the dynamic packet format 720, as illustrated in FIG. 7. The 20 bits in a conventional ACT packet illustrated in FIG. 6 are mapped to 20 bits in the dynamic format illustrated in FIG. 7, with the OPCODE and bank address moved to the fix-positioned bits and the row address carried in the rest of the bits. The 20 bits in a conventional RD or WR packet illustrated in FIG. 6 are mapped to 16 bits, in one of the two formats illustrated in FIG. 7. The two rfu bits in the conventional RD or WR packet are removed in the dynamic format. The 20 bits in a conventional PRE packet illustrated in FIG. 6 are mapped to eight bits in the dynamic format illustrated in FIG. 7, which only retains the OPCODE bits and the bank address. In the following description, the two formats for RD/WR packets are referred to as “format 0” and “format 1,” respectively. The ACT packet format is referred to as “format 3,” and the PRE packet format is referred to as “format 2.”

Effectively, the unused space around a PRE CA packet in the dynamic format is reallocated to RD or WR packets. The selection of RD/WR format depends on whether the preceding memory operation is an ACT operation or a PRE operation. If the preceding packet is an activation operation, RD/WR format 518-2 is used. If the preceding packet is a precharge operation, RD/WR format 518-4 is used.

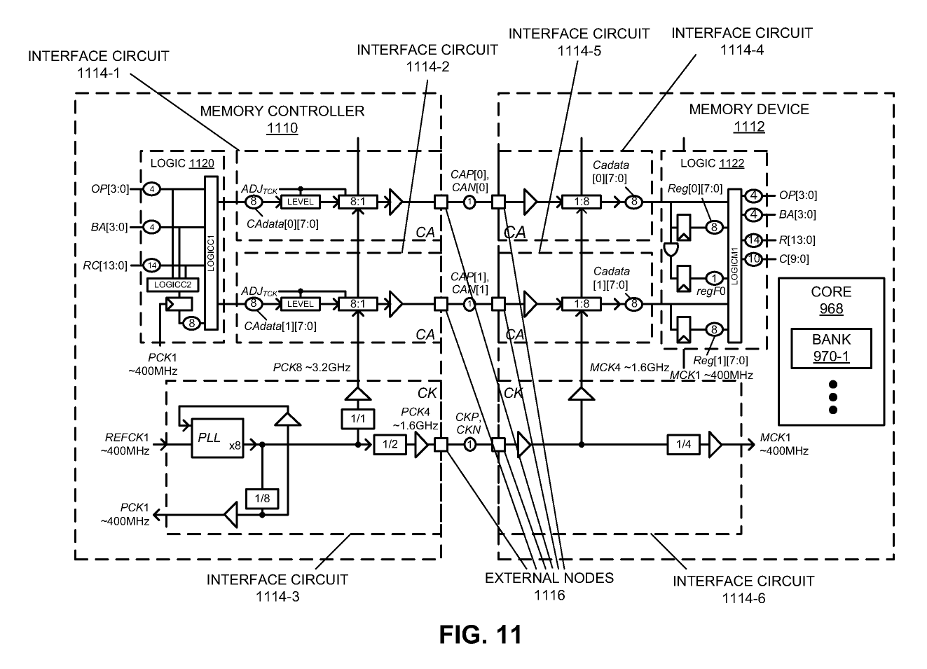

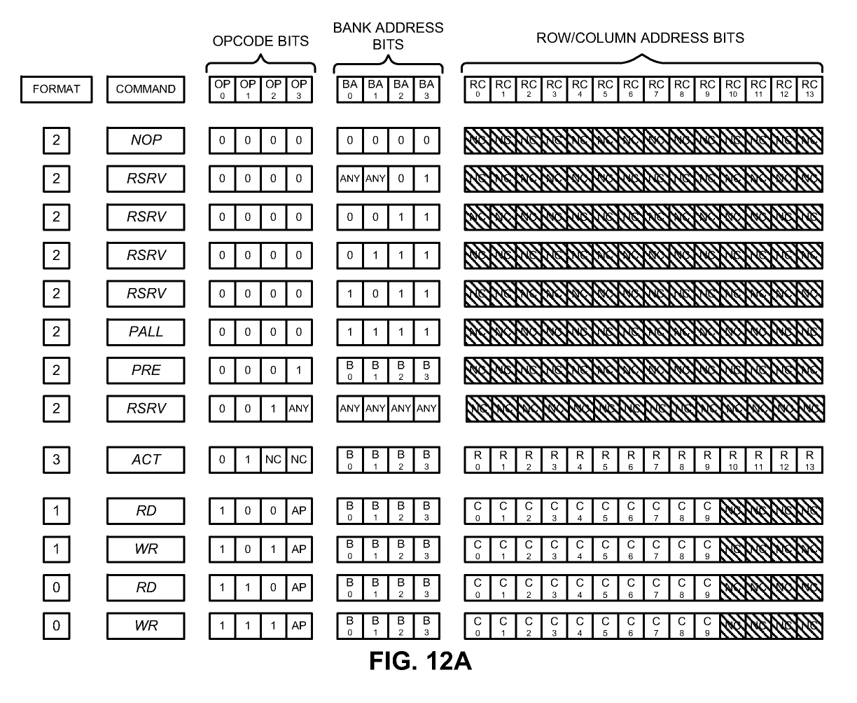

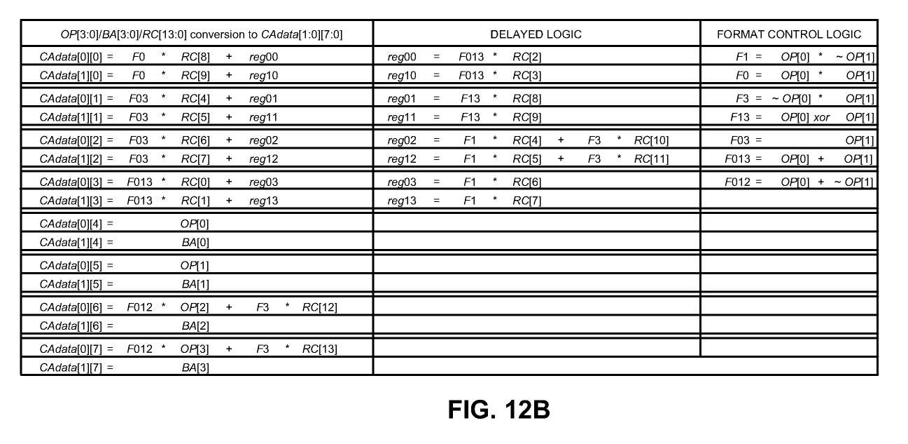

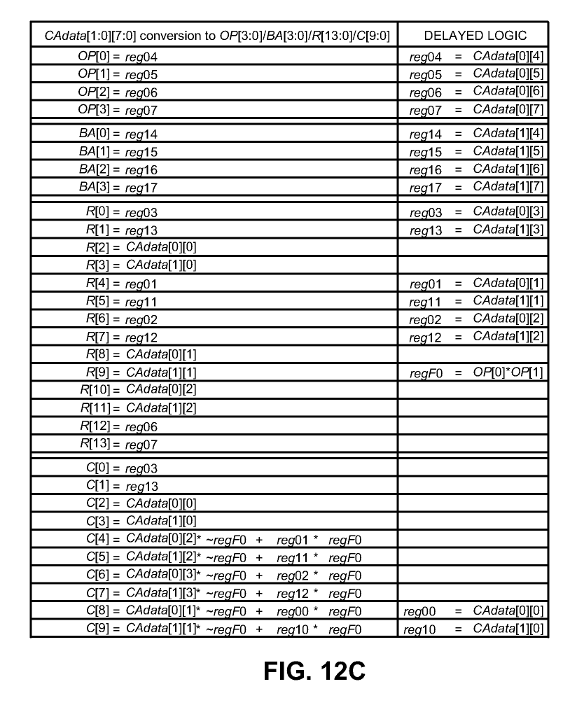

As described further below with reference to FIGS. 11, 12B and 12D, the dynamic shifting of the CA packets with respect to the DFI clock boundaries can be performed in the PHY interfaces in the memory controller and the memory device.

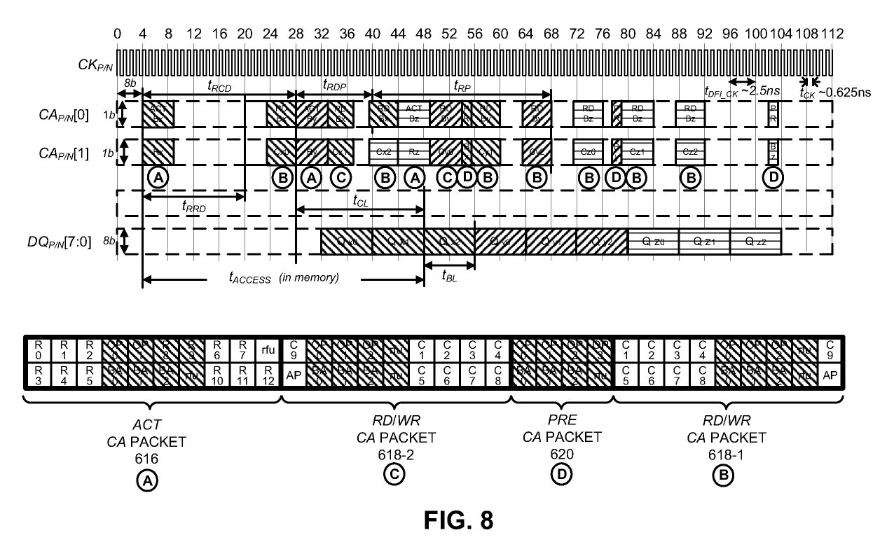

FIG. 8 illustrates how three column accesses to the same bank and row address can be pipelined with DFI-clock cycle accuracy using the dynamic CA format illustrated in FIGS. 6 and 7. For reference, the formats of the CA packets are shown at the bottom of FIG. 8. The format of ACT packet format 516 is denoted by “A;” the first format of RD/WR packet 518-1 is designated by “B;” the second format of RD/WR packet 518-2 is designated by “C;” and the format of PRE packet 520 is designated by “D.” Note that the OPCODE and bank-address bits are different in each of these formats, and can be used to identify the format of a CA packet. Furthermore, because of space constraints, precharge is sometimes denoted by “PR” in FIG. 8 (for example at physical clock cycle 54).

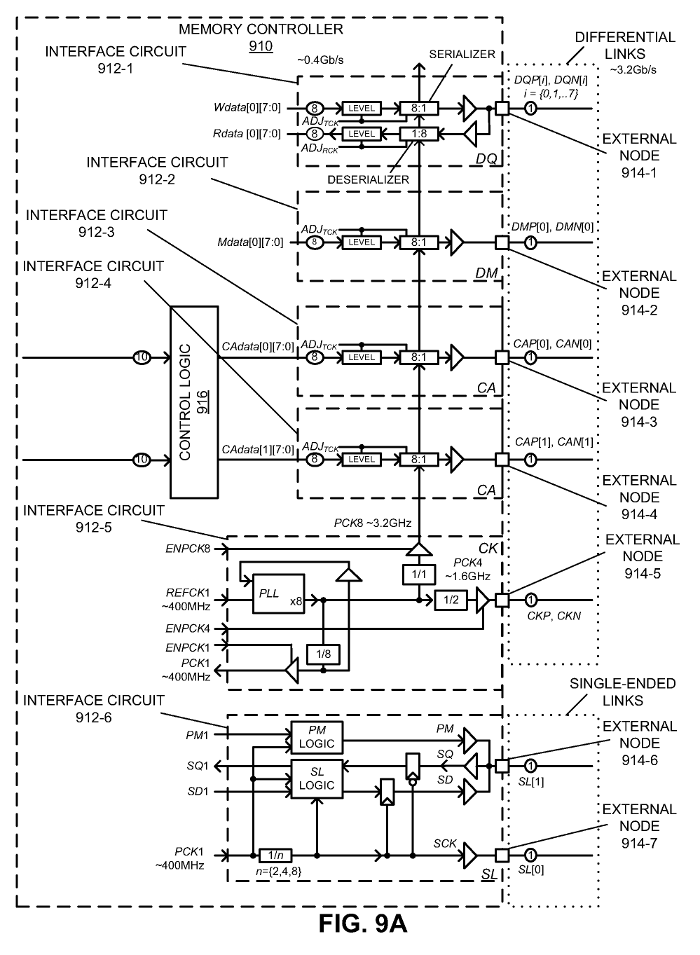

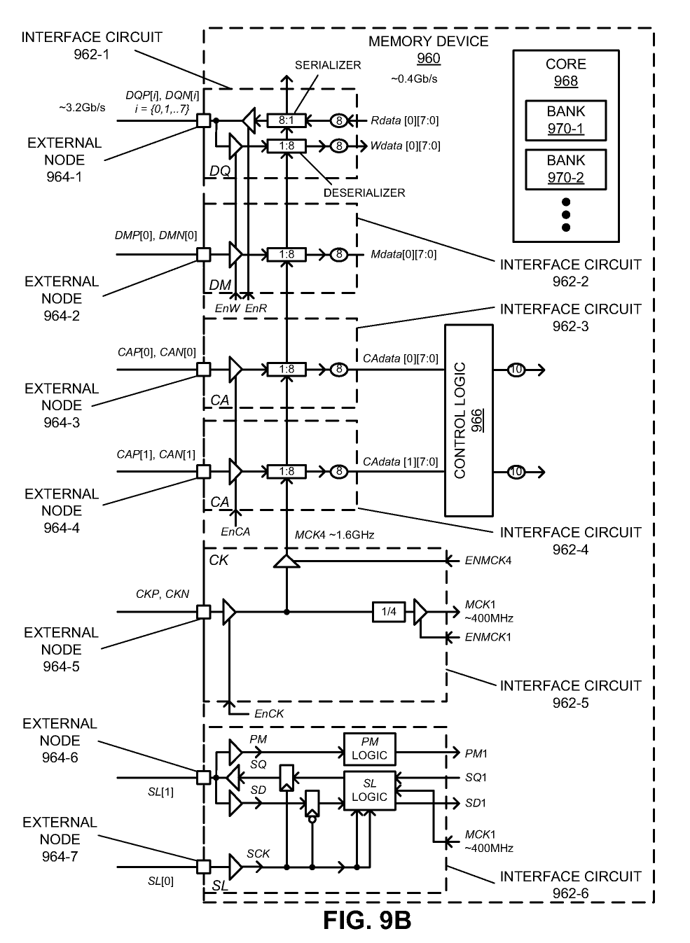

As shown in FIG. 8, the returned data for three column operations to column addresses Cx0, Cx1, and Cx2 tile continuously on the DQ bus, because of the DFI-clock cycle-accurate pipelining of the CA packets. It can be observed that on the two CA links the CA packets often extend beyond the DFI clock boundaries. This flexibility allows the CA packets to be cycle-accurate with respect to commands issued by the memory controller. To implement this CA protocol, additional logic can be added between the physical clock domain and the memory-controller-clock domain (also referred to as the DFI clock domain in this disclosure). Ideally, the additional logic circuitry is “invisible” to the MC controller logic, so that the design of the controller logic does not need to be changed with the PHY interface is upgraded. These additional gates are described below with reference to FIGS. 9A, 9B, 11, 12B and 12D.

FIG. 9A illustrates an exemplary memory controller 910 in a memory system. In memory controller 910, interface circuits 912 transmit and receive information on external nodes 914 for communication to and from memory device 960 (see FIG. 9B). Note FIG. 9A only illustrates PHY interface circuit 912-1 for one of the 8-bit-wide data bus links (DQP[i], DQN[i], i={0, 1, . . . , 7}). The PHY interface circuits for the other data bus links can be configured in a similar manner. Furthermore, this example illustrates only two CA links. In other embodiments, the memory system can include fewer or more CA links.

In memory controller 910, high-speed serializers/deserializers in interface circuit 912-1 convert between a serial bit sequence (transmitted to or received from external node 914-1) and an 8-bit-wide parallel bit sequence used by memory controller 910. There is also a control logic 916 between the 0.4 Gbps and 3.2 Gbps clock domains, which may be implemented in either clock domain.

Control logic 916 receives CA information in a DFI format (see FIG. 2) and converts it using the present CA protocol described in conjunction with FIG. 5. In particular, control logic 916 alters the packet format of the CA commands and outputs CA packets with 20-bit, 18-bit, or 8-bit formats based on the memory operation in the current DFI clock cycle and/or in the previous DFI clock cycle.

FIG. 9B presents an integrated circuit memory device 960, which is coupled to memory controller 910 (see FIG. 9A) in a memory system. In this memory device, interface circuits 962 transmit and receive information on external nodes 964 for communication to or from memory controller 910. FIG. 9B illustrates PHY interface circuit 962-1 for one of the 8-bit-wide data bus links (DQP[i], DQN[i], i={0, 1, . . . , 7}). The PHY interface circuits for the other data bus links can be configured in a similar manner.

In memory device 960, high-speed serializers/deserializers in interface circuit 962-1 convert between a serial bit sequence (transmitted to or received from external node 914-1) and an 8-bit-wide parallel bit sequence used by memory device 960 for write or read data. There is also a control logic 966, which receives CA packets and extracts the corresponding address information and commands based on the CA protocol described in conjunction to FIG. 5. These memory commands are then performed by memory core 968.

Memory core 968 may include multiple memory banks 970. Using the aforementioned CA protocol, during a number of read operations to one of the memory banks (such as memory bank 970-1), the corresponding read data packets can be serialized on the data links without any gap between them.

CA packets associated with a given memory operation are communicated to memory device 960 via external nodes 964-3 and 964-4 and their corresponding interface circuits 962-3 and 962-4. In situations where memory controller 910 maintains an open-page policy in memory core 968, the aforementioned CA protocol can provide cycle-accurate matching of CA packets received via the PHY interfaces and the CA packets produced by control logic 966.

As noted previously, the format of a CA packet may be selected based on the current memory operation and/or the immediately preceding memory operation. In some embodiments, a memory operation is identified from the OPCODE bits in the corresponding CA packet. For read or write operations, the two CA packet formats result in the same operation on memory core 968. The deserializers in interface circuit 962-4 may indicate where to find the column address in the received CA packet. In one embodiment, there are common OPCODE bits for the two CA packet formats for a read or write command, and the proper format can be inferred from the OPCODE bits in the immediately preceding CA information. In other words, the format of a read or write command is determined based on whether the preceding command is an activation command or precharge command.

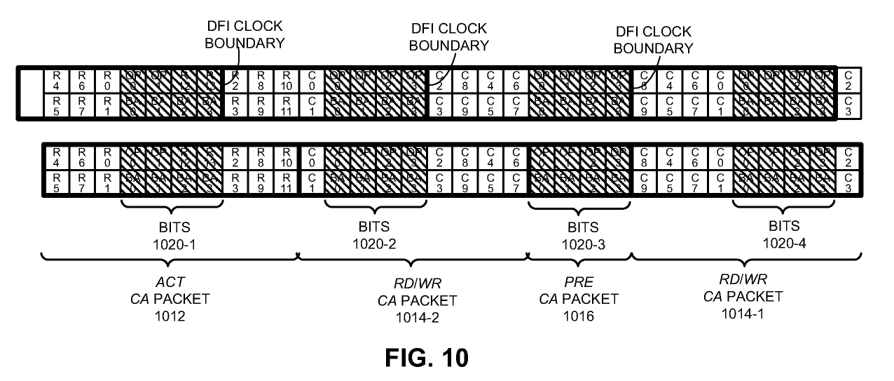

Although the discussion above is based on the exemplary CA protocol illustrated in FIG. 5, embodiments of the present invention can accommodate various CA packet formats. FIG. 10 illustrates such a variation. In this example, the relative position of fixed-position bits 1020 with respect to the DFI clock boundary is different from that illustrated in FIG. 5. Furthermore, the arrangement of row address bits in an ACT packet 1012 and the arrangement of column address bits in RD or WR packets 1014 is also different from that shown in FIG. 5. PRE packet 1016's format remains the same. The dynamic CA protocol in FIG. 10 may be implemented using fewer gates in control logic 916 (see FIG. 9A) and/or 966 (see FIG. 9B) than required by the protocol illustrated in FIG. 5.

FIG. 11 illustrates control logic 916 (of FIG. 9A) and 966 (of FIG. 9B) in more detail. In this memory system, interface circuits 1114 in memory controller 1110 and memory device 1112 transmit and receive information via external nodes 1116 and the corresponding links. Interface circuits 1114-1, 1114-2, 1114-4, and 1114-5 jointly provide the PHY interfaces for the two CA links between memory controller 1110 and memory device 1112. Interface circuits 1114-3 and 1114-6 facilitate the communication of clock signals from memory controller 1110 to memory device 1112. Logic 1120 in memory controller 1110 implements control logic 916 (see FIG. 9A) and Logic 1122 in memory device 1112 implements control logic 966 (see FIG. 9B).

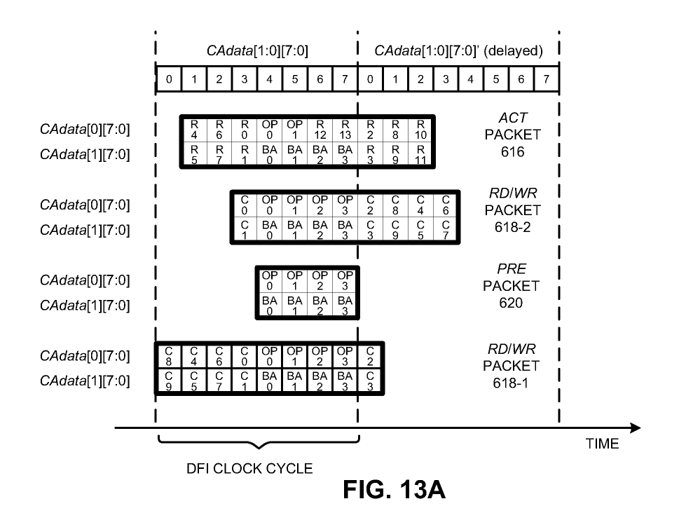

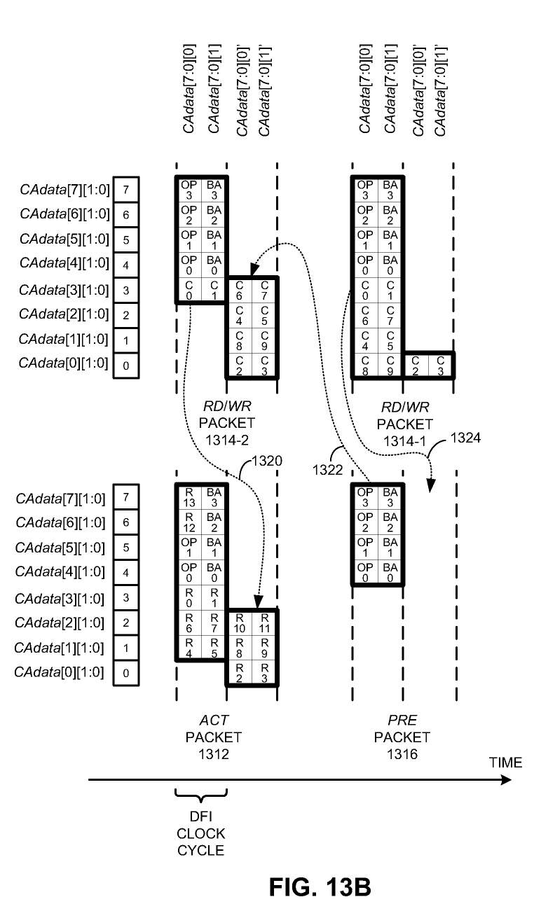

FIG. 12A illustrates different OPCODE and address bits corresponding to different CA packet formats associated with different memory operations. The OPCODE bits may be used to identify the current memory operation (i.e., activate, precharge, read, or write), as well as the format of the CA packet, such as the two formats for RD/WR packets). The examples illustrated in FIGS. 12a, 12b, 12c, 13a, and 13b assume that the packet format and encoding illustrated in FIG. 10 is used.

The present dynamic CA protocol includes a sufficient number of reserved (RSRV) commands for future use. In some embodiments, the reserved commands can use packet format 2 (see FIG. 7) to take advantage of the RC[0:13] field (where RC indicates the combined row/column address, while R and C, respectively, are the row and column addresses). Furthermore, packet format 0 is selected when a RD or WR operation follows an ACT packet, and packet format 1 is selected when a RD or WR operation follows a PRE packet. In this example, the OPCODE of a RD or WR packet identifies the packet format. For example, a RD packet of format 0 has the first three OPCODE bits as “110,” whereas a RD packet of format 1 has these bits as “100.” Hence, the memory device does not need to infer the current packet format based on the preceding packet. If the format 0/format 1 encoding of a RD/WR packet were inferred from the preceding packet, ¼ of the OP[3:0] encoding space could be recovered for other commands. In one embodiment, these two alternatives (i.e., packet format being indicated explicitly in OPCODE or being inferred based on the preceding packet) are both are implemented and selected modally in the controller and the memory components using a register or other means to statically configure at initialization.

FIG. 12B presents an exemplary logic computation table for implementing the dynamic CA protocol in a memory controller. The logic equations in FIG. 12B should be read from left to right. “XOR” designates an exclusive OR Boolean-logic operation; “+” designates an OR Boolean-logic operation; “*” designates an AND Boolean-logic operation; and “˜” designates a NOT Boolean-logic operation. The format control logic values, denoted as “F” values, and the delayed values stored in registers, denoted as “reg” values, are used as intermediate values in calculating the final values to be placed on the CA links. The values to be placed on a CA link during a DFI clock cycle is denoted as CAdata[i][j], wherein “i” denotes the CA link, and “j” denotes the bit index within the DFI clock cycle (recall that due to the faster PHY clock a CA link can carry 8 bits during one DFI clock cycle).

FIG. 12C presents an exemplary logic computation table for implementing the dynamic CA protocol in a memory device. The right column of FIG. 12C illustrates how the 16 bits received on the two CA links during a DFI clock cycle can be stored in various registers. The left column illustrates the OPCODE, bank address, row address, and column address bits that can be used by a control logic in the memory device. The logic equations in FIGS. 12B and 12C are presented as examples. These logic equations may be further optimized and simplified.

As noted above, the dynamic CA protocol can be used to convert from a fixed, 20-bit CA-packet format to variable-size CA-packet format. Although the previous examples are described based on two CA links operating at a 3.2 Gbps data rate, the CA protocol can be modified to accommodate a wider and slower CA bus while still providing cycle accuracy with respect to the DFI clock cycles. FIGS. 13A and 13B illustrate a comparison between such two embodiments. FIG. 13A illustrates the four packet formats based on two CA links, each operating at 3.2 Gbps as described earlier in conjunction with FIGS. 6 and 7. In contrast, FIG. 13B presents the packet formats of a CA bus that is slower and wider. In this example, the CA bus includes 8 CA links, and each DFI clock cycle can carry two bits. The notation “CAdata[i][j]” denotes the ith CA link, at jth bit position during a DFI clock cycle. For example, CAdata[7][1:0] refers to two bits carried during a DFI clock cycle on the 7th CA link. The notation “CAdata[i][j]′” denotes the bits from a packet that starts in the preceding DFI clock cycle which are delayed and placed in the current DFI clock cycle. As can be seen in FIG. 13B, all four packet formats for ACT, PRE, and RD/WR packets have the first two OPCODE bits, OP0 and OP1, placed at bit positions CAdata[4][0] and CAdata[5][0], respectively.

RD/WR packet format 1314-2 is used when the preceding packet is an ACT packet 1312, so that the beginning of RD/WR packet 1324-2 fits with the end of ACT packet 1312 as indicated by dotted curve 1320. A PRE packet 1316 can then follow RD/WR packet 1314-2, as indicated by dotted curve 1322. After PRE packet 1322, a RD/WR packet with format 1314-1 can be placed in the available DFI clock cycle immediately following the OPCODE bits of PRE packet 1322, as indicated by dotted curve 1324.

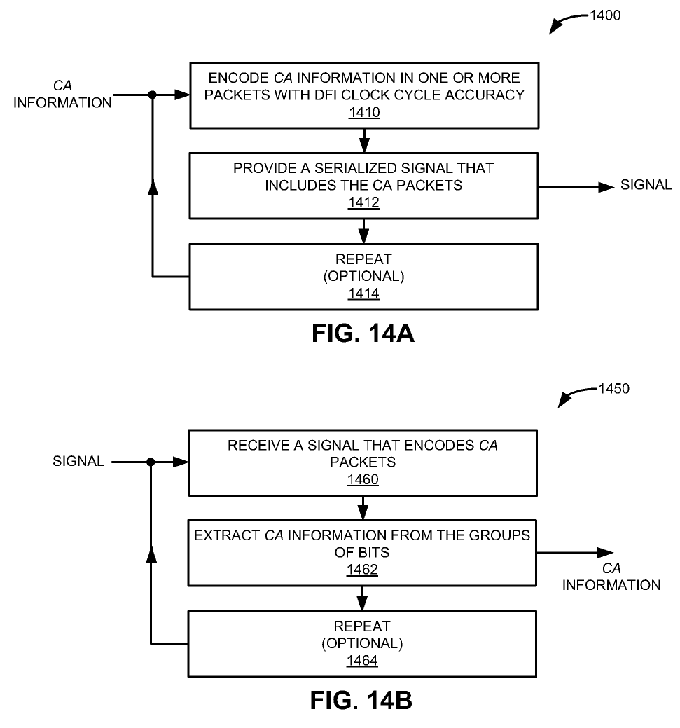

We now describe processes that may be performed by the PHY interface in the memory controller and the memory device to implement the dynamic CA protocol. FIG. 14A illustrates a process 1400 for providing CA signals on the physical CA links, which may be performed by control logic 916 in FIG. 9A and logic 1120 in FIG. 11. During process 1400, the control logic encodes the CA information associated with memory operations in CA packets using the aforementioned dynamic CA protocol with DFI clock cycle accuracy (operation 1410). Then, the control logic provides a serialized signal that includes the CA packets (operation 1412). Note that for the different memory operations, there are at least two formats of the CA packet, and that the at least two formats have different sizes, different framing positions or both. Operations 1410 and 1412 may be optionally repeated (operation 1414) for additional memory operations.

FIG. 14B illustrates a process 1450 for receiving CA signals on the physical links, which may be performed by control logic 966 in FIG. 9B and logic 1122 in FIG. 11. During process 1450, the control logic receives a signal that encodes CA packets (operation 1460). Then, the control logic extracts the CA information associated with memory operations from the received signal using the aforementioned dynamic CA protocol (operation 1462). Operations 1460 and 1462 may be optionally repeated (operation 1464) for additional received signals.

In some embodiments of processes 1400 and 1450, there may be additional or fewer operations. Moreover, the order of the operations may be changed, and/or two or more operations may be combined into a single operation.

The described embodiments may include fewer or additional components. For example, interface circuits 912-3 and/or 912-4 (FIG. 9A) may be replaced by an equivalent means for encoding CA information. Components may be combined into a single component and/or the position of one or more components may be changed. For example, control logic 916 may be included in interface circuits 912-3 and 912-4 in FIG. 9A, and control logic 966 may be included in interface circuits 962-3 and 962-4 in FIG. 9B. In some embodiments, some or all of the functionality associated with a memory controller in a memory system is included in a processor. Thus, there may or may not be a separate memory controller in the memory system.

An output of a process for designing an integrated circuit, or a portion of an integrated circuit, comprising one or more of the circuits described herein may be a computer-readable medium such as, for example, a magnetic tape or an optical or magnetic disk. The computer-readable medium may be encoded with data structures or other information describing circuitry that may be physically instantiated as an integrated circuit or portion of an integrated circuit. Although various formats may be used for such encoding, these data structures are commonly written in Caltech Intermediate Format (CIF), Calma GDS II Stream Format (GDSII) or Electronic Design Interchange Format (EDIF). Those of skill in the art of integrated circuit design can develop such data structures from schematic diagrams of the type detailed above and the corresponding descriptions and encode the data structures on a computer-readable medium. Those of skill in the art of integrated circuit fabrication can use such encoded data to fabricate integrated circuits comprising one or more of the circuits described herein.

While the present disclosure has been described in connection with specific embodiments, the claims are not limited to what is shown. For example, in some embodiments the links between a memory controller and a memory device utilize half-duplex and/or full-duplex communication (e.g., communication on a given link may be in both directions). Similarly, the links between a memory controller and a memory device may operate at a data rate that is: a multiple of the clock frequency such as DDR, quad-data rate (QDR), or high multiple data rates. Additionally, data or commands may be communicated using other encoding or modulation techniques than an embodiment of the CA protocol.

Moreover, some components are shown directly connected to one another, while others are shown connected via intermediate components. In each instance the method of interconnection, or ‘coupling,’ establishes some desired electrical communication between two or more circuit nodes, or terminals. Such coupling may often be accomplished using a number of circuit configurations, as will be understood by those of skill in the art. For example, the foregoing embodiments support AC-coupled links, DC-coupled links, or both. Therefore, the spirit and scope of the appended claims should not be limited to the foregoing description. Only those claims specifically reciting “means for” or “step for” should be construed in the manner required under the sixth paragraph of 35 U.S.C. §112.

What is claimed is:

1. A memory device, comprising:
a memory core including a plurality of memory cells; and
an interface circuit to receive a memory operation command that specifies a memory operation pertaining to an access of the memory core, wherein the memory operation command is specified in a packet that includes the memory operation command multiplexed with address information corresponding to the access; and
wherein a framing position marking the start of the packet is adjusted based at least on one prior received packet, received by the interface circuit.

2. The memory device of claim 1, wherein the interface circuit comprises a packet delineation mechanism to dynamically determine the format of the packet.

3. The memory device of claim 2, wherein the packet delineation mechanism determines the format of a received packet based at least on a corresponding memory operation specified in the packet.

4. The memory device of claim 2, wherein the packet delineation mechanism determines the format of a received packet based at least on the memory operation specified in an immediately preceding packet.

5. The memory device of claim 1, wherein the memory operation includes one of an activate, precharge, read, and write operation.

6. The memory device of claim 5, wherein memory operation commands specifying one of a read and write operation, are each specified using at least two packet formats.

7. The memory device of claim 1, wherein the packet includes an operation code specifying the memory access operation, wherein the operation code of the packet begins at a fixed position relative to a boundary of recurring time periods, each of which having a predetermined duration.

8. The memory device of claim 7, wherein the beginning of a respective packet is at a position before or after the beginning of the corresponding time period; and
wherein the end of a respective packet is at a position before or after the end of the corresponding time period.

9. The memory device of claim 1, wherein the packet is of a first size and the at least one prior received packet is of a second size, wherein the first size is different than the second size.

10. A memory controller, comprising:
an interface circuit to transmit a memory operation command that specifies an access to a memory core of a memory device;
wherein the memory operation command is specified in a packet that includes the memory operation command multiplexed with address information corresponding to the access; and
wherein a framing position marking the start of the packet is adjusted based at least on one prior transmitted packet transmitted by the interface circuit.

11. The memory controller of claim 10, wherein the interface circuit comprises a packet formatting mechanism to dynamically determine a format of packets to be transmitted.

12. The memory controller of claim 11, wherein the packet formatting mechanism determines the format of a packet based at least on the corresponding memory operation specified in the packet.

13. The memory controller of claim 11, wherein the packet formatting mechanism determines the format of a packet based at least on the memory operation specified in an immediately preceding packet.

14. The memory controller of claim 11, wherein the memory operation is one of an activate, precharge, read, and write operation.

15. The memory controller of claim 14, wherein memory operation commands specifying one of a read and write operation, are each specified using at least two different packet formats.

16. The memory controller of claim 11, wherein the packet includes an operation code specifying the memory access operation; and
wherein the operation code of the packet begins at a fixed position relative to a boundary of recurring time periods, each of which having a predetermined duration.

17. The memory controller of claim 16, wherein the beginning of a respective packet is at a position before or after the beginning of the corresponding time period; and
wherein the end of a respective packet is at a position before or after the end of the corresponding time period.

18. The memory controller of claim 10, wherein the packet is of a first size and the at least one prior transmitted packet is of a second size, wherein the first size is different than the second size.

19. A memory device, comprising:
means for receiving memory operation commands using a serialized control and address protocol;
wherein a respective command is specified in a packet;
wherein at least two received packets have different sizes; and
wherein a framing position marking the beginning of a respective packet is dynamically adjusted based at least on one or more prior packets.

20. A memory controller, comprising:
means for transmitting memory operation commands using a serialized control and address protocol;
wherein a respective command is specified in a packet;
wherein at least two received packets have different sizes; and
wherein a framing position marking the beginning of a respective packet is dynamically adjusted based at least on one or more prior packets.

21. A system, comprising:
a bus;
a memory controller comprising a first interface circuit coupled to the bus and configured to transmit memory operation commands using a serialized control and address protocol; and
a memory device comprising a second interface circuit coupled to the bus and configured to receive the memory operation commands;
wherein a respective memory operation command is specified in a packet;
wherein at least two received packets have different sizes; and
wherein a framing position marking the beginning of a respective packet is adjusted based at least on one or more prior packets.

22. A method for receiving information, comprising:
receiving a signal that includes groups of bits formatted using a serialized control and address protocol as a packet; and
extracting information associated with memory operations from the groups of bits;
wherein, for a respective memory operation of the memory operations, there are at least two packet sizes; and
wherein a framing position marking the beginning of a respective packet is adjusted based at least on one or more prior packets.

23. A method for providing information, comprising:
encoding information associated with memory operations into groups of bits using a serialized control and address protocol; and
transmitting a signal that includes the groups of bits in a packet format;
wherein, for a respective memory operation, there are at least two packet sizes; and
wherein a framing position marking the beginning of a respective packet is adjusted based at least on one or more prior packets
